(19) United States
(12) Patent Application Publication
(10) Pub. No.: US 2019/0009423 A1
(43) Pub. Date: Jan. 10, 2019

(54) DEVICE AND METHOD FOR REMOVING A RESIDUAL MATERIAL

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Chunchin Huang, Chongqing (CN)

(21) Appl. No.: 15/745,076

(22) PCT Filed: Sep. 5, 2017
(86) PCT No.: PCT/CN2017/100538

§ 371 Date: Jan. 15, 2018

(30) Foreign Application Priority Data
Dec. 12, 2016 (CN) 201611143797.6

(51) Int. Cl. B26F 1/14

(52) U.S. Cl. CPC B26F 1/14

(57) ABSTRACT

The present application provides a device and a method for removing a residual material, wherein, the device for removing a residual material includes: a cutting-transporting portion configured to cut a bulk material; a pressing-moving portion being in contact with the cut bulk material and configured to apply a pressure to the residual material on the cut bulk material, such that the residual material is separated along a cutting line from the cut bulk material to obtain a base piece; and a splitter coupled to the cutting-transporting portion and configured to split the base piece. The pressing-moving portion is further configured to lift the base piece up to above the cutting-transporting portion, and then moving the base piece to the splitter.

### FIELD OF THE INVENTION

The present application relates to the technical field of mechanical automation, and more particularly relates to a device and a method for removing a residual material.

### BACKGROUND OF THE INVENTION

With the continuous development of mechanical automated technology, a mechanical device has gradually replaced a traditional manual labour and played a huge role in an automated production. A cutting device is a common type of the mechanical device, which is configured to cut a bulk material. Thus, the cut bulk material is transported to a splitting machine for splitting to obtain a processed base piece.

However, in a practical application, in the process that the cut bulk material is transported to the splitting machine, the residual material on the bulk material may be prone to fall off to scratch the base piece, which leads to the base piece being damaged and unusable, and thereby reducing a yield.

### SUMMARY OF THE INVENTION

An embodiment of the present application provides a device and a method for removing a residual material. A pressure is applied to the residual material on the cut bulk material, such that the residual material on the cut bulk material is separated from a base piece, and thus the base piece is lifted up to above the cutting-transporting portion and then moved to the splitter. Therefore, the base piece cannot be scratched by the residual material, so that a yield is improved.

An embodiment of the present application provides a device for removing a residual material, including:

a cutting-transporting portion configured to cut a bulk material;

a pressing-moving portion being in contact with the cut bulk material and configured to apply a pressure to the residual material on the cut bulk material, such that the residual material is separated along a cutting line from the cut bulk material to obtain a base piece; and

a splitter, mechanically coupled to the cutting-transporting portion, and configured to split the base piece;

wherein the pressing-moving portion is further configured to lift the base piece up to above the cutting-transporting portion, and then moving the base piece to the splitter.

In an embodiment, the pressing-moving portion includes:

a pressing portion configured to contact with the residual material, and applying the pressure to the residual material;

a moving portion configured to contact with the base piece, lifting the base piece up to above the cutting-transporting portion, and then moving the base piece to the splitter; and

a mechanical bracket coupled to the pressing portion and the moving portion, and configured to fix the pressing portion and the moving portion, and driving the pressing portion and the moving portion to move.

In an embodiment, the pressing portion comprises:

a frame, wherein a shape of the frame is in conformity with a shape of the residual material; and

a plurality of pressing terminals, which are all fixed to the frame and arranged to face towards the residual material.

In an embodiment, the plurality of pressing terminals are arranged in a regular array at a bottom of the frame.

In an embodiment, the moving portion comprises a plurality of suction cups, and each of the suction cups is fixed at the bottom of the mechanical bracket and is arranged to face towards the base piece.

In an embodiment, the suction cup is a vacuum suction cup.

In an embodiment, the pressing portion comprises:

a rectangular frame;

four first pressing terminals respectively arranged on four corners of the rectangular frame and facing towards four corners of the residual material; and

a plurality of second pressing terminals respectively arranged on a lower surface of the rectangular frame, and facing towards an upper surface of the residual material.

In an embodiment, the plurality of second pressing terminals are arranged in a regular array at a bottom of the rectangular frame.

In an embodiment, the device further comprises a driving motor, which is coupled to the mechanical bracket, and is configured to drive the pressing portion and the moving portion to move via the mechanical bracket.

In an embodiment, the driving motor is a servo motor.

In an embodiment, the device for removing a residual material further comprises a control portion, which is coupled to the driving motor, and is configured to control an operating state of the driving motor.

In an embodiment, the control portion is a personal computer terminal.

In an embodiment, the cutting-transporting portion is a wheel cutter, and the splitter is a steam splitter.

In an embodiment, the bulk material is selected from the group consisting of a steel plate, a glass sheet, a ceramic plate, a wood, a printed circuit board and a liquid crystal panel.

An embodiment of the present application provides a method for removing a residual material, which is performed through the above device for removing the residual material, and comprises:

controlling the cutting-transporting portion to cut a bulk material;

controlling the pressing-moving portion to contact with a cut bulk material, applying a pressure to the residual material on the cut bulk material, such that the residual material is separated from the cut bulk material along a cutting line to obtain a base piece, and moving the base piece to the splitter; and

controlling the splitter to split the base piece.

An embodiment of the present application provides a device for removing a residual material, including:

a cutting control unit configured to control a cutting-transporting portion to cut a bulk material;

a pressing control unit configured to control a pressing-moving portion into contact with a cut bulk material, applying a pressure to the residual material of the cut bulk material, such that the residual material is separated from the cut bulk material along a cutting line to obtain a base piece, and moving the base piece to the splitter; and

a splitting control unit configured to control a splitter to split the base piece.

In the embodiments of the present application, a pressure is applied to the residual material on the cut bulk material, such that the residual material on the cut bulk material is separated from a base piece, and the base piece is lifted up to above the cutting-transporting portion and then moved to the splitter. Therefore, the base piece cannot be scratched by the residual material, so that a yield is improved; the structure is simple, and is suitable for being widely used.

### BRIEF DESCRIPTION OF THE DRAWINGS

In order to describe the technical solutions in the embodiments of the present application more clearly, accompanying drawings required for describing the embodiments or the prior art will be briefly introduces. Apparently, the accompanying drawings in the following description are merely the embodiments of the present application, and other drawings may be obtained by those skilled in the art according to these accompanying drawings without paying any creative labor.

FIG. 1 is a structural block diagram of a device for removing a residual material provided by an embodiment of the present application;

FIG. 2 is a structural schematic view of a cut bulk material provided by one embodiment of the present application;

FIG. 3 is a structural schematic view of a cut bulk material provided by another embodiment of the present application;

FIG. 4 is a schematic view of a state of a base piece moving to a splitter provided by an embodiment of the present application;

FIG. 5 is a structural schematic view of a pressing portion provided by an embodiment of the present application;

FIG. 6 is a structural block diagram of a device for removing a residual material provided by one embodiment of the present application;

FIG. 7 is a flow chart of a method for removing a residual material provided by an embodiment of the present application;

FIG. 8 is a structural block diagram of a device for removing a residual material provided by another embodiment of the present application; and

FIG. 9 is a structural block diagram of a system for removing a residual material provided by an embodiment of the present application.

### DETAILED DESCRIPTION OF THE PREFERRED EMBODIMENT

In order to make those skilled in the art better understand the technical solutions of the present application, the technical solutions of the embodiments of the present application will be further described in detail hereinafter with reference to accompanying drawings in the embodiments of the present application. Apparently, the described embodiments are merely a part of the embodiments of the present application, but not all of the embodiments. All other embodiments obtained by those skilled in the art based on the embodiments of the present application without creative efforts shall fall within the protecting scope of the present application.

In the specification, claims, and accompanying drawings of the present application, the term “comprising” and any variations thereof, are intended to cover non-exclusive inclusion. For example, a process, method or apparatus, and product or device, which comprises a series of steps or units, is not limited to the listed steps or units, but may alternatively further include steps or units that are not listed, or alternatively include other steps or units inherent to the process, method, product or device. In addition, the terms “first”, “second”, “third” and the like are configured to distinguish different objects, rather than to describe a particular order.

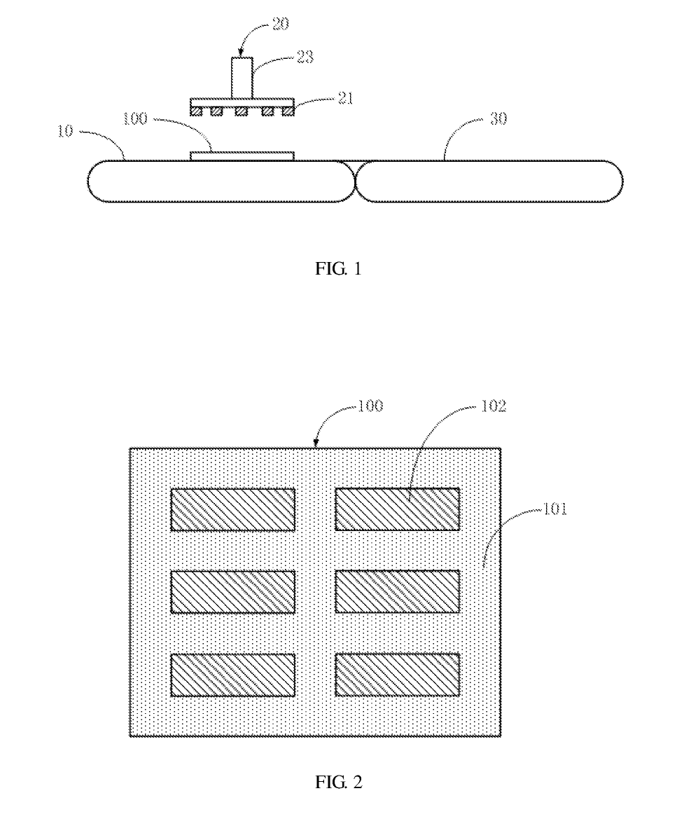

As shown in FIGS. 1, an embodiment of the application provides a device for moving a residual material, which includes a cutting-transporting portion 10, a pressing-moving portion 20 and a splitter 30.

The cutting-transporting portion 10 is configured to cut a bulk material 100.

In specific applications, the cutting-transporting portion may be specifically a wheel cutter, a laser cutter, a flame cutter, a plasma cutter, a water cutter, or the like. The different cutter may be selected according to the bulk material that specifically needs to be cut.

In a specific application, the bulk material may be any material that needs to be cut, such as a steel plate, a glass sheet, a ceramic plate, a wood, a printed circuit board, a liquid crystal panel, and the like.

The pressing-moving portion 20 is contacted with the cut bulk material and is configured to apply a pressure to the residual material 101 on the cut bulk material 100, such that the residual material 101 is separated from the cut bulk material 100 along a cutting line to obtain a base piece 102, and then the base piece 102 is lifted up to above the cutting-transporting portion 10, and then moved the base piece to the splitter 30.

In a specific application, a method for moving the base piece via the pressing-moving portion may be lifting the base piece up to a preset height above the cutting-transporting portion, then horizontally moving the base piece above the splitter, and then vertically moving and placing the base piece onto the splitter.

As shown in FIG. 2, a rectangular bulk material 100 is exemplarily shown in an embodiment. After being cut the rectangular bulk material 100, the residual material 101 and a plurality of the rectangular base pieces 102 arranged in a rectangular array are obtained.

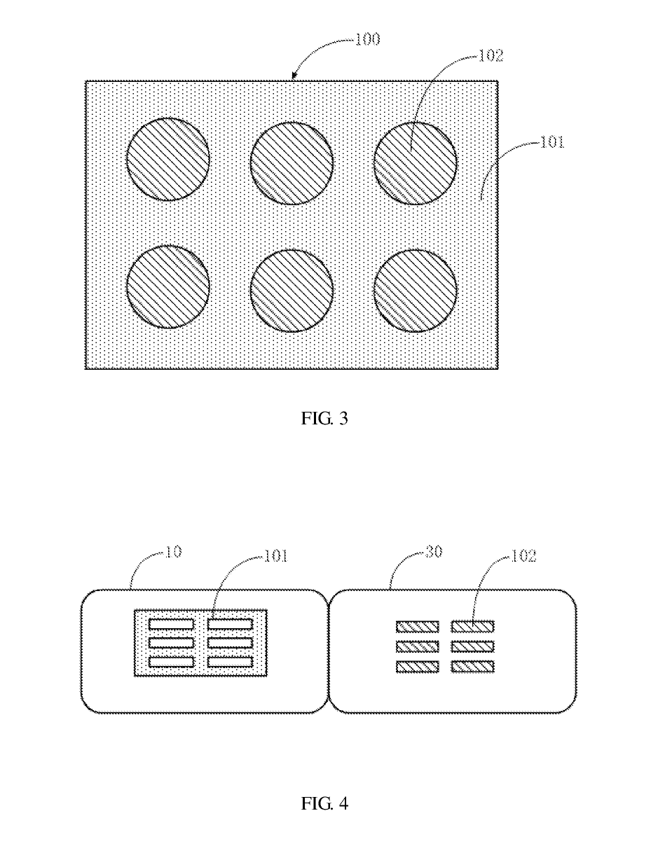

As shown in FIG. 3, in a specific application, after being cut the rectangular bulk material 100, the residual material 101 and a plurality of the circular base pieces 102 arranged in a rectangular array are obtained.

As shown in FIG. 4, a top view of a state of the rectangular base pieces 102 transported to the splitter 30 via the pressing-moving portion 20 after cutting the rectangular bulk material 100 as shown in FIG. 2, which is exemplarily shown in an embodiment.

As shown in FIG. 1, in an embodiment, the pressing-moving portion 20 includes a pressing portion 21, a moving portion 22 (not shown in the drawings), and a mechanical bracket 23.

The pressing portion 21 is configured to contact the residual material 101, and applying a pressure to the residual material 101.

In a specific application, the pressing portion includes a frame, and a shape of the frame is in conformity with a shape of the residual material. A plurality of pressing terminals are fixed to the frame and arranged to face towards the residual material.

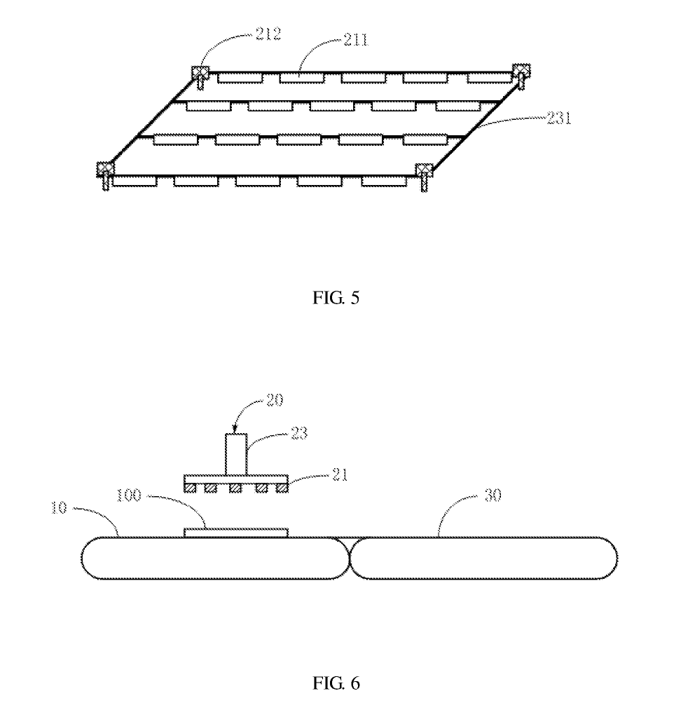

In a specific application, when the cut bulk material 100 is in a structure as shown in FIG. 2, the pressing portion 21 can be a structure as shown in FIG. 5. As shown in FIG. 5, the pressing portion 21 includes a rectangular frame 211, and a size of the rectangular frame 211 may be just enough to cover the residual material 101. Four corners of the rectangular frame 211 are provided with four cylinder first pressing terminals 212, respectively, which are faced towards four corners of the residual material 101. An upper end of the first pressing terminal 212 is fixed on the rectangular frame 211. A lower surface of the rectangular frame 211 distributes a plurality of second pressing terminals 231 facing towards an upper surface of the residual material 101. The plurality of second pressing terminals 231 are arranged in a regular array at a lower surface of the rectangular frame 211.

A moving portion 22 is configured to contact with the base piece 102, lifting the base piece 102 up to above the cutting-transporting portion 10, and then moving the base piece 102 to the splitter 30.

In a specific application, the pressing portion includes a plurality of suction cups, which are all fixed at a bottom of the mechanical bracket and arranged to face towards the base piece. The suction cup may be selected as a vacuum suction cup.

A mechanical bracket 23 is coupled to the pressing portion 21 and the moving portion 22, and is configured to fix the pressing portion 21 and the moving portion 22 and driving the pressing portion 21 and the moving portion 22 to move.

A splitter 30 is mechanically connected with the cutting-transporting portion 10, and is configured to split the base piece 102.

In a specific application, the splitter 30 may be selected as a steam splitter.

As shown in FIG. 6, in an embodiment of the present application, the device for moving the residual material further includes a driving motor 40.

The driving motor 40 is connected with the mechanical bracket 23, and is configured to drive the pressing portion 21 and the moving portion 22 to move.

In a specific application, the driving motor may be a servo motor.

In one embodiment of the present application, the device for moving the residual material further includes a control portion connected with the driving motor, and is configured to control an operating state of the driving motor.

In a specific application, the control portion may specifically be a personal computer terminal, or may be implemented by a general purpose integrated circuit, such as a Central Processing Unit (CPU), or an Application Specific Integrated Circuit (ASIC).

The embodiment of the present application provides a device for removing a residual material. According to applying a pressure to the residual material, a cutting line on the bulk material is break under the press, and the residual material may be separated from a base piece; then lifting the base piece up to above the cutting-transporting portion, and then transporting to the splitter, so that it can effectively prevent the residual material from falling off to scratch the base piece, and thereby improve a yield of a cutting process.

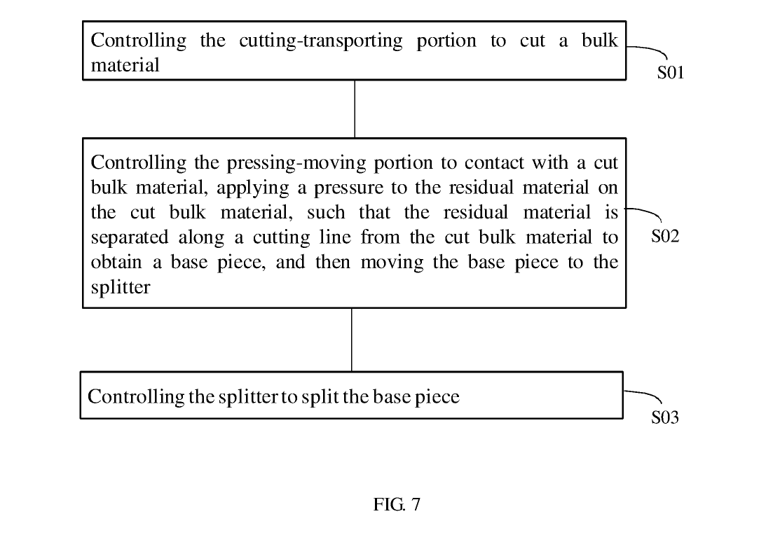

As shown in FIG. 7, a method for moving a residual material is provided with one embodiment of the present application, which is implemented by the device for moving the residual material provided with the above embodiment, and the method includes:

a step S01, controlling the cutting-transporting portion to cut a bulk material.

In a specific application, according to a preset cutting requirement, the bulk material can be cut into a preset shape and a preset number of a base piece. For example, a rectangular liquid crystal glass panel with six moduli may be cut into six liquid crystal panels; and lumber for manufacturing a round stool is cut into a plurality of circular plates configured to manufacture a panel of the stool.

a step S02, controlling the pressing-moving portion to contact with a cut bulk material, applying a pressure to the residual material on the cut bulk material, such that the residual material is separated along a cutting line from the cut bulk material to obtain a base piece, and then moving the base piece to the splitter.

In a specific application, the pressure applied to the residual material may be an impact pressure generated a rapid impact, so that the cutting line between the residual material and the base piece may be quickly broken due to an instantaneous stress.

In an embodiment of the present application, the step of moving the base piece to the splitter specifically includes:

controlling the pressing-moving portion to lift the base piece up to a preset height above the cutting-transporting portion, then horizontally moving the base piece above the splitter, and then vertically moving and placing the base piece onto the splitter.

In a specific application, the preset height may be set according to an actual requirement.

a step S03, controlling the splitter to split the base piece.

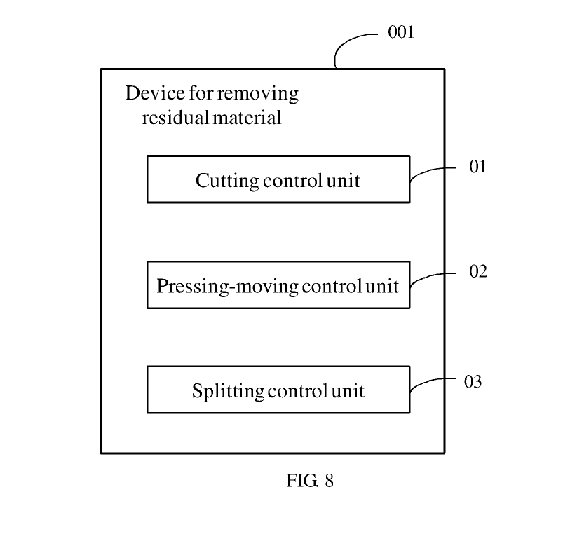

As shown in FIG. 8, an embodiment of the present application provides a device for moving a residual material 001, which includes:

a cutting control unit 01 configured to control a cutting-transporting portion to cut a bulk material;

a pressing-movement control unit 02 configured to control the pressing-moving portion to contact with a cut bulk material, applying a pressure to the residual material on the cut bulk material, such that the residual material is separated along a cutting line from the cut bulk material to obtain a base piece, and then moving the base piece to the splitter; and

a splitting control unit 03 configured to control the splitter to split the base piece.

In a specific application, the cutting control unit 01, the pressing-movement control unit 02, and the splitting control unit 03 may be implemented by a Central Processing Unit (CPU), or an Application Specific Integrated Circuit (ASIC).

In a specific application, the device for removing a residual material 001 may specifically be a control portion itself or a soft program medium implemented by the control portion.

According to an embodiment of the present application, the device for removing the residual material 001 further includes:

a first movement control unit configured to control the pressing-moving portion to lift the cut bulk material up to above the cutting-transporting portion, and then moving the base piece to the splitter.

According to an embodiment of the present application, the device for removing the residual material 001 further includes:

a second movement control unit configured to control the pressing-moving portion to lift the base piece up to a preset height above the cutting-transporting portion, then horizontally moving the base piece above the splitter, and then vertically moving and placing the base piece onto the splitter.

An embodiment of the present application provides device and method for moving a residual material, and the above device for removing the residual material is controlled to cut the bulk material and then to separate the residual material after being cut, so that it can effectively prevent the base piece from scratch, and improve a yield of a product.

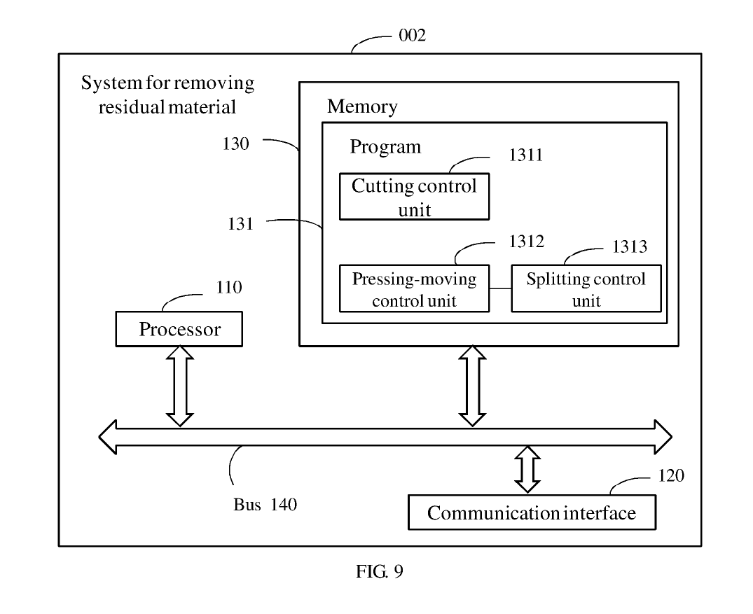

As shown in FIG. 9, an embodiment of the present application provides a system for removing a residual material 002 implemented via the device for removing the residual material provided by the above embodiment, which includes:

a processor 110, a communication interface 120, a memory 130, and a bus 140.

The processor 110, the communication interface 120, and the memory 130 are communicated via the bus 140.

The communication interface 120 is configured to communicate with an external device, such as a personal computer, a smart phone, or the like.

The processor 110 is configured to process a program 131.

Specifically, the program 131 may include a program code, and the program code includes a computer operating instruction.

The processor 110 may be a central processing unit (CPU), an application specific integrated circuit (ASIC), or one or more integrated circuits implemented by the embodiments of the present application.

The processor 30 is configured to save the program 131. The processor 130 may include a high speed RAM memory, or a non-volatile memory, such as at least one disk memory. The program 131 may specifically include:

a cutting control unit 1311 configured to control a cutting-transporting portion to cut a bulk material;

a pressing-movement control unit 1312 configured to control a pressing-moving portion to contact with a cut bulk material, and applying a pressure to the residual material on the cut bulk material, such that the residual material is separated along a cutting line from the cut bulk material to obtain a base piece, and moving the base piece to the splitter; and

a splitting control unit 1213 configured to control a splitter to split the base piece.

In an embodiment of the present application, the program 131 may further include:

a first movement control unit configured to control the pressing-moving portion to lift the cut bulk material up to above the cutting-transporting portion, and then moving the base piece to the splitter.

In an embodiment of the present application, the program 131 may further include:

a second movement control unit configured to control the pressing-moving portion to lift the base piece up to a preset height above the cutting-transporting portion, then horizontally moving the base piece above the splitter, and then vertically moving and placing the base piece onto the splitter.

In a specific application, all embodiments of the present application may be applied in a manufacturing process of a base piece of a display panel, where the display panel may be any type of display panel, such as, an LCD (Liquid Crystal Display) panel, an OLED (Organic Electroluminescence Display) panel, a QLED (Quantum Dot Light Emitting Diodes) panel, or the like.

The steps in the method in this embodiment of the present application may be sequentially adjusted, combined, and deleted according to actual needs.

The units in a device in this embodiment of the present application may be combined, divided, and deleted according to actual needs.

A person skill in the art may understand that all or part of the processes for implementing the methods in the aforementioned embodiments may be implemented by a computer program instructing relevant hardware. The program may be stored in a computer-readable storage medium. When the procedure is processed, the flow of the embodiments of the above methods may be included. The storage medium may be a magnetic disk, an optical disk, a read-only memory (ROM), a random access memory (RAM), or the like.

The aforementioned embodiments are only preferred embodiments of the present application, and are not used for limiting the present application. Any modification, equivalent replacement, improvement, and so on, which are made within the spirit and the principle of the present application, should be included in the protection scope of the present application.

What is claimed is:

1. A device for removing a residual material, comprising:
a cutting-transporting portion configured to cut a bulk material;
a pressing-moving portion being in contact with the cut bulk material and configured to apply a pressure to the residual material on the cut bulk material, such that the residual material is separated along a cutting line from the cut bulk material to obtain a base piece; and
a splitter, mechanically coupled to the cutting-transporting portion, and configured to split the base piece;
wherein the pressing-moving portion is further configured to lift the base piece up to above the cutting-transporting portion, and then moving the base piece to the splitter.

2. The device of claim 1, wherein the pressing-moving portion comprises:
a pressing portion configured to contact with the residual material, and applying the pressure to the residual material;
a moving portion configured to contact with the base piece, lifting the base piece up to above the cutting-transporting portion, and then moving the base piece to the splitter; and
a mechanical bracket coupled to the pressing portion and the moving portion, and configured to fix the pressing portion and the moving portion, and driving the pressing portion and the moving portion to move.

3. The device of claim 2, wherein the pressing portion comprises:
a frame, wherein a shape of the frame is in conformity with a shape of the residual material; and
a plurality of pressing terminals, which are all fixed to the frame and arranged to face towards the residual material.

4. The device of claim 3, wherein the plurality of pressing terminals are arranged in a regular array at a bottom of the frame.

5. The device of claim 2, wherein the moving portion comprises a plurality of suction cups, and each of the suction cups is fixed at the bottom of the mechanical bracket and is arranged to face towards the base piece.

6. The device of claim 5, wherein the suction cup is a vacuum suction cup.

7. The device of claim 2, wherein the pressing portion comprises:
a rectangular frame;
four first pressing terminals respectively arranged on four corners of the rectangular frame and facing towards four corners of the residual material; and
a plurality of second pressing terminals respectively arranged on a lower surface of the rectangular frame, and facing towards an upper surface of the residual material.

8. The device of claim 7, wherein the plurality of second pressing terminals are arranged in a regular array at a bottom of the rectangular frame.

9. The device of claim 2, wherein the device further comprises a driving motor, which is coupled to the mechanical bracket, and is configured to drive the pressing portion and the moving portion to move via the mechanical bracket.

10. The device of claim 9, wherein the driving motor is a servo motor.

11. The device of claim 10, wherein the device for removing a residual material further comprises a control portion, which is coupled to the driving motor, and is configured to control an operating state of the driving motor.

12. The device of claim 11, wherein the control portion is a personal computer terminal.

13. The device of claim 1, wherein the cutting-transporting portion is a wheel cutter, and the splitter is a steam splitter

14. The device of claim 1, wherein the bulk material is selected from the group consisting of a steel plate, a glass sheet, a ceramic plate, a wood, a printed circuit board and a liquid crystal panel.

15. A method for removing a residual material through the device of the claim 1, comprising:
controlling the cutting-transporting portion to cut a bulk material;
controlling the pressing-moving portion to contact with a cut bulk material, applying a pressure to the residual material on the cut bulk material, such that the residual material is separated from the cut bulk material along a cutting line to obtain a base piece, and moving the base piece to the splitter; and
controlling the splitter to split the base piece.

16. The method for removing the residual material of claim 15, wherein before the step of controlling the splitter to split the base piece, the method comprises:
controlling the pressing-moving portion to lift the base piece up to above the cutting-transporting portion, and then moving the base piece to the splitter.

17. The method for removing the residual material of claim 16, wherein before the step of splitting the base piece by controlling the splitter, the method comprises:
controlling the pressing-moving portion to lift the base piece up to a preset height above the cutting-transporting portion, then horizontally moving the base piece to above the splitter, and then vertically moving and placing the base piece onto the splitter.

18. A device for removing a residual material, comprising:
a cutting control unit configured to control a cutting-transporting portion to cut a bulk material;
a pressing control unit configured to control a pressing-moving portion into contact with a cut bulk material, applying a pressure to the residual material of the cut bulk material, such that the residual material is separated from the cut bulk material along a cutting line to obtain a base piece, and moving the base piece to the splitter; and
a splitting control unit configured to control a splitter to split the base piece.

19. The device of claim 18, wherein the device further comprises:
a first movement control unit configured to control the pressing-moving portion to lift the base piece up to above the cutting-transporting portion, and then moving the base piece to the splitter.

20. The device of claim 18, wherein the device for removing the residual material further comprises:
a second movement control unit configured to control the pressing-moving portion to lift the base piece up to a preset height above the cutting-transporting portion, then horizontally moving the base piece above the splitter, and then vertically moving and placing the base piece onto the splitter.
